(19) United States
(12) Patent Application Publication
(10) Pub. No.: US 2018/0126542 A1
(43) Pub. Date: May 10, 2018

(54) Carpenter's Workstation

(71) Applicant: Robert Huckle, Sarnia (CA)

(72) Inventor: Robert Huckle, Sarnia (CA)

(21) Appl. No.: 15/343,405

(22) Filed: Nov. 4, 2016

(51) Int. Cl. B25H 1/12; A47B 46/00; A47B 81/00; A47B 88/04; A47B 88/00; A47B 83/04; B25H 1/06

(52) U.S. Cl. CPC B25H 1/12; A47B 46/005; A47B 81/00; B25H 1/06; A47B 88/0044; A47B 83/045; A47B 88/04

(57) ABSTRACT

A carpenter's workstation for facilitating installation and repair of doors includes a pair of cabinets. Each cabinet comprises a housing and defines an internal space. A plurality of slots is positioned in a front face of the housing. Each cabinet comprises a plurality of drawers that is complementary to the slots. The drawers are configured to position within the slots. Each of a pair of saw horses is hingedly coupled to a rear of a respective cabinet proximate to an upper limit of the respective cabinet. The saw horses are collapsible. Each drawer is selectively and reversibly insertable through a respective slot into the internal space. Respective drawers are configured to support a door that is positioned across the respective drawers with a side of the door positioned adjacent to the front faces of the cabinets. The saw horses are positioned on the cabinets such that the saw horses are positioned to pivot from the cabinets to an extended configuration.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to carpenter's workstations and more particularly pertains to a new carpenter's workstation for facilitating installation and repair of doors.

### BRIEF SUMMARY OF THE INVENTION

An embodiment of the disclosure meets the needs presented above by generally comprising a pair of cabinets. Each cabinet comprises a housing and defines an internal space. A plurality of slots is positioned in a front face of the housing. Each cabinet comprises a plurality of drawers that is complementary to the slots. The drawers are configured to position within the slots. Each of a pair of saw horses is hingedly coupled to a rear of a respective cabinet proximate to an upper limit of the respective cabinet. The saw horses are collapsible. Each drawer is selectively and reversibly insertable through a respective slot into the internal space. Respective drawers are configured to support a door that is positioned across the respective drawers with a side of the door positioned adjacent to the front faces of the cabinets. The saw horses are positioned on the cabinets such that the saw horses are positioned to pivot from the cabinets to an extended configuration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a carpenter's workstation according to an embodiment of the disclosure.

FIG. 2 is an isometric perspective view of an embodiment of the disclosure.

FIG. 3 is a side view of an embodiment of the disclosure.

FIG. 4 is a back view of an embodiment of the disclosure.

FIG. 5 is a side view of an embodiment of the disclosure.

FIG. 6 is an isometric perspective view of an embodiment of the disclosure.

FIG. 7 is an isometric perspective view of an embodiment of the disclosure.

FIG. 8 is an isometric perspective view of an embodiment of the disclosure.

### DETAILED DESCRIPTION OF THE INVENTION

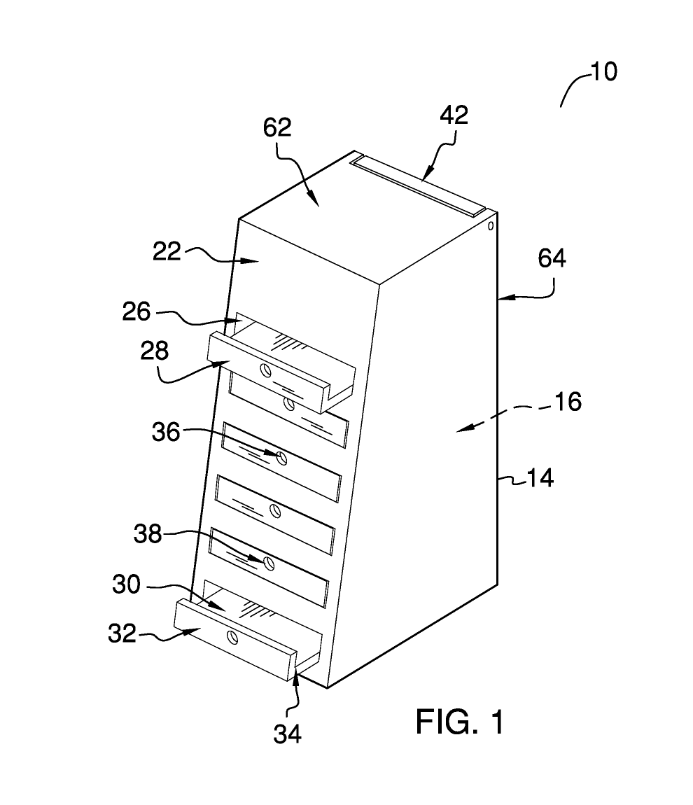

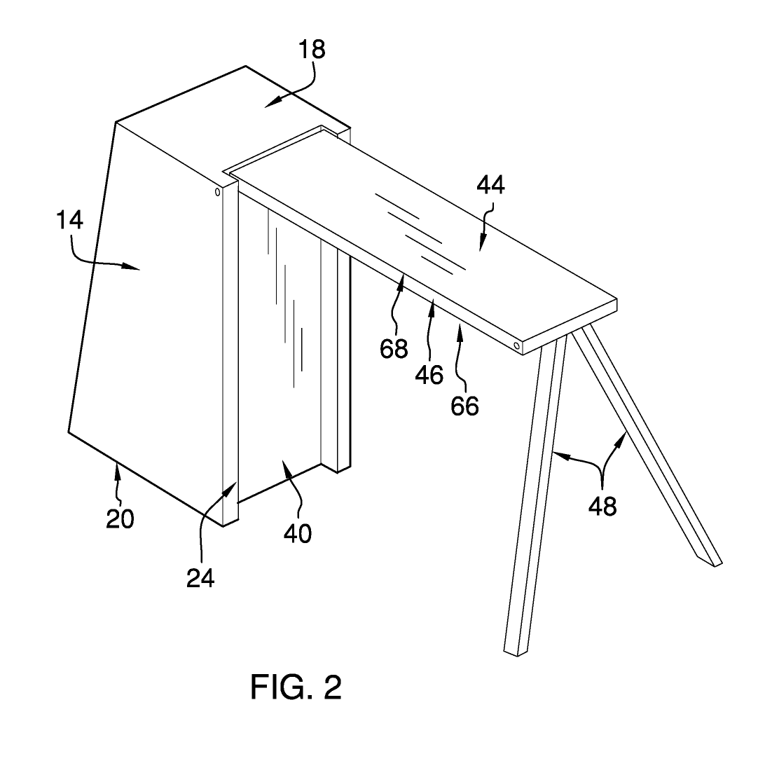

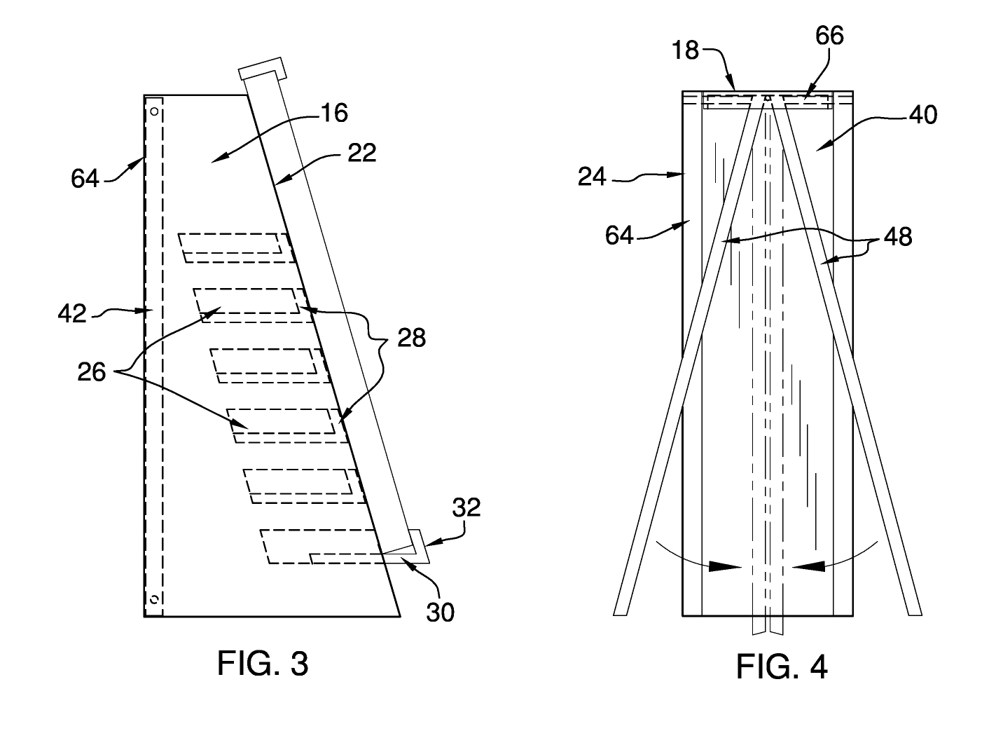

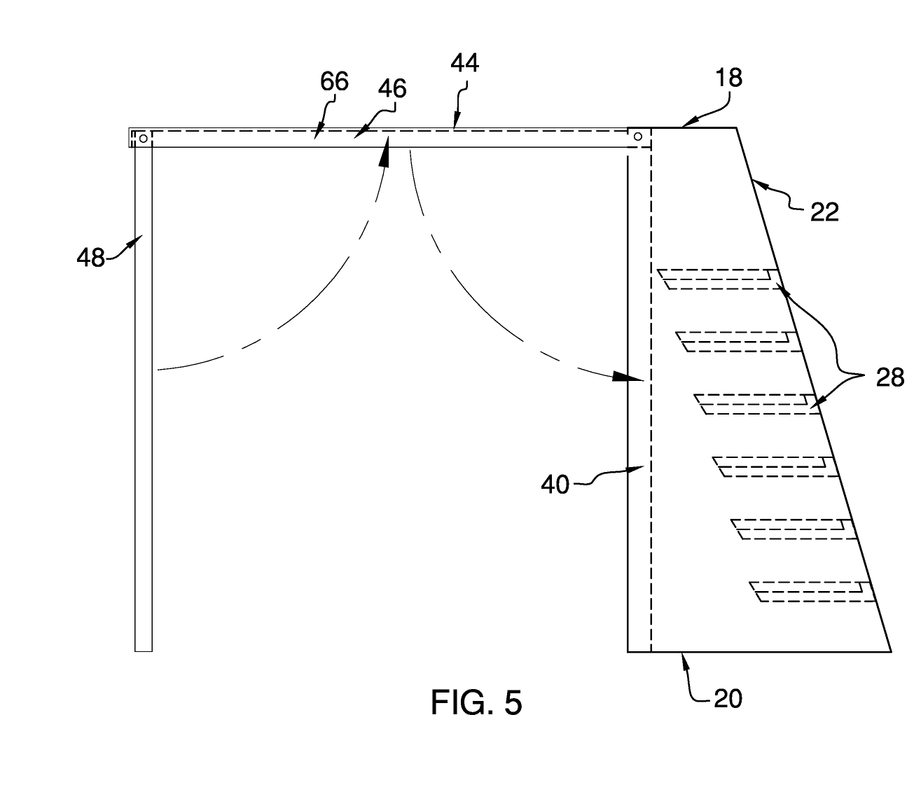

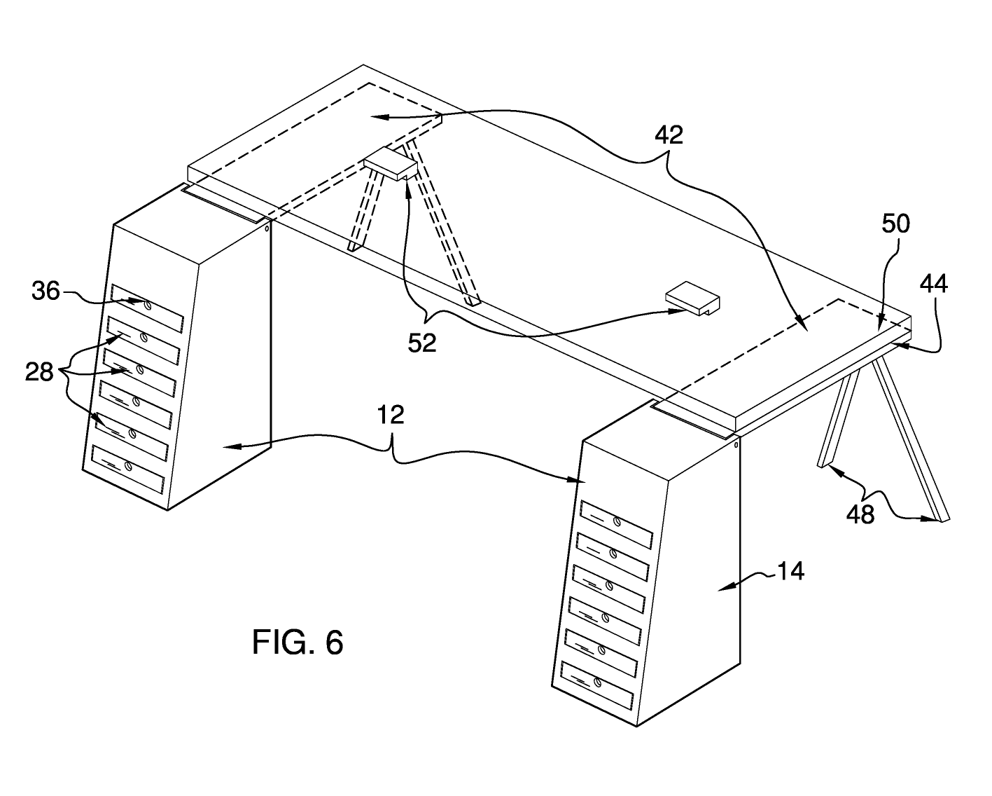

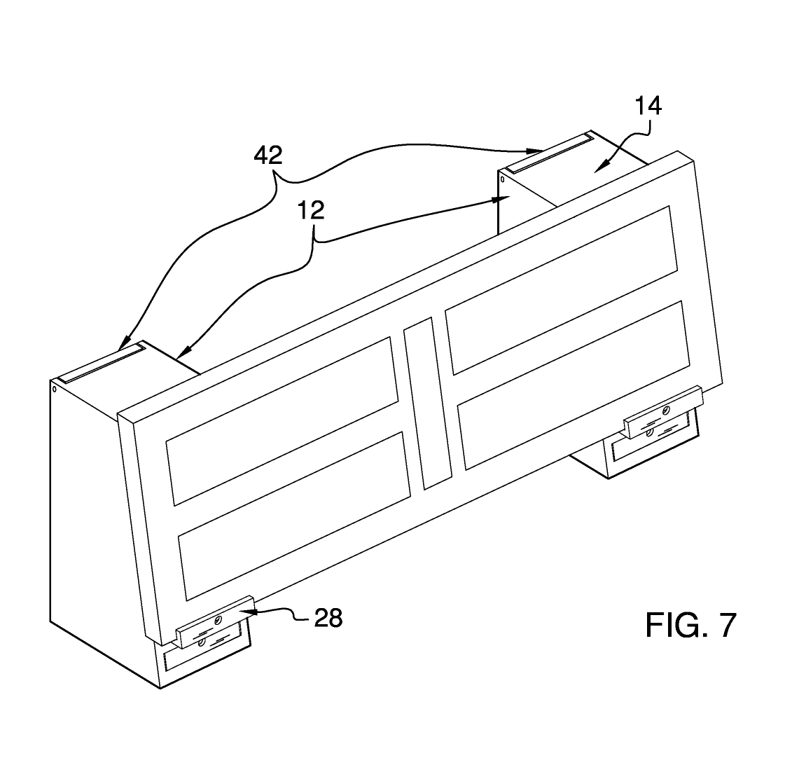

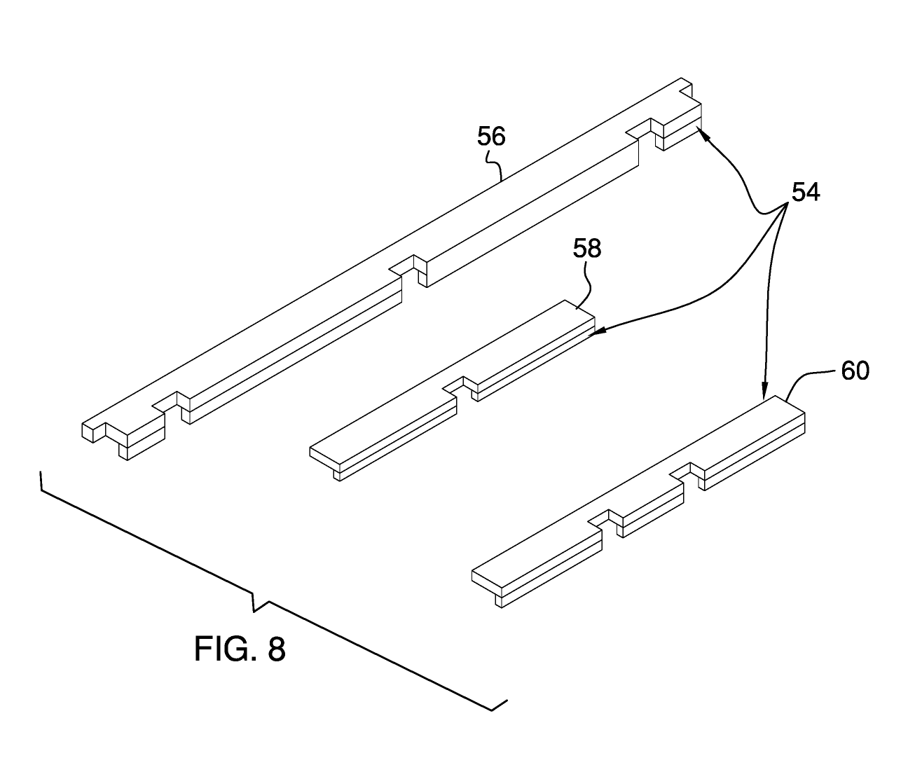

With reference now to the drawings, and in particular to FIGS. 1 through 8 thereof, a new carpenter's workstation embodying the principles and concepts of an embodiment of the disclosure and generally designated by the reference numeral 10 will be described.

As best illustrated in FIGS. 1 through 8, the carpenter's workstation 10 generally comprises a pair of cabinets 12. Each cabinet 12 comprises a housing 14 that defines an internal space 16. The housing 14 is substantially rectangularly box shaped. The housing 14 has a top 18 and a bottom 20. In one embodiment, the bottom 20 is dimensionally larger that the top 18 such that a front face 22 of the housing 14 extends angularly from the bottom 20 to the top 18. A back face 24 of the housing 14 extends perpendicularly from the bottom 20 to the top 18.

A plurality of slots 26 is positioned in the front face 22 of the housing 14. Each cabinet 12 comprises a plurality of drawers 28 that is complementary to the slots 26. Each drawer 28 is selectively and reversibly insertable through a respective slot 26 into the internal space 16. The drawers 28 are configured to position within the slots 26 such that respective drawers 28 are configured to support a door that is positioned across the respective drawers 28, with a side of the door positioned adjacent to the front faces 22.

In one embodiment, the plurality of drawers 28 comprises from one to ten drawers 28. In another embodiment, the plurality of drawers 28 comprises from two to eight drawers 28. In yet another embodiment, the plurality of drawers 28 comprises six drawers 28.

Each drawer 28 comprises a bottom plate 30. A front plate 32 is coupled to a front edge 34 of the bottom plate 30. The front plate 32 extends angularly from the bottom plate 30 such that the front plate 32 is flush to the front face 22 of the housing 14 when the drawer 28 is fully inserted into the respective slot. A pull 36 is coupled to the front plate 32. The pull 36 is substantially centrally positioned on the front plate 32. The pull 36 is positioned on the front plate 32 such that the pull 36 is configured for a user to motivate the drawer 28 from an inserted position to an open position. In one embodiment, the pull 36 comprises an orifice 38 that is positioned through the front plate 32. The orifice 38 is positioned through the front plate 32 such that the orifice 38 is configured to insert at least one digit of a hand of the user.

A recess 40 is positioned in the back face 24 of the housing 14. The recess 40 extends from the bottom 20 to the top 18 of the housing 14.

Each of a pair of saw horses 42 is hingedly is coupled to a rear 64 of a respective cabinet 12 proximate to an upper limit 62 of the respective cabinet 12. The saw horses 42 are collapsible. The saw horses 42 are positioned on the cabinets 12 such that the saw horses 42 are positioned to pivot from the cabinets 12 to an extended configuration. The saw horses 42 are complementary to the recesses 40, such that each saw horse 42 is stowable in an associated recess 40.

Each saw horse 42 comprises a top plate 44, a pair of side plates 46 and a pair of legs 48. Each side plate 46 is coupled singularly to and extends perpendicularly from an opposing edge 68 of the top plate 44. The top plate 44 and side plates 46 define a channel 66 66. Each of a pair of legs 48 is dual pivotally coupled to the top plate 44 distal from the housing 14. The legs 48 are positioned on the top plate 44 such that the legs 48 are configured to position substantially perpendicularly from the top plate 44 to retain the top plate 44 in a substantially horizontal configuration. The legs 48 are pivotable to substantial parallelism with the top plate 44 such that the legs 48 are positioned within the channel 66 and the saw horse 42 is positioned for stowing within the recess 40. The legs 48 also are positioned on the top plate 44 such that the legs 48 are configured to position in a splayed configuration. The legs 48 are inverted-V-shaped when viewed from the back face 24 of the housing 14.

The workstation 10 comprises a table top 50 that is rigid. The table top 50 is configured to position across the pair of saw horses 42 when the saw horses 42 are in the extended configuration, such that the table top 50 is supported in a substantially horizontal position. The table top 50 provides a work surface for the user. In one embodiment, the table top 50 is foldable.

The workstation 10 comprises a pair of jam holders 52. Each jam holder 52 is reversibly couplable to a respective saw horse 42. The jam holder 52 is positionable on the saw horse 42 such that the jam holder 52 is configured to hold a jam of a door that is positioned across the pair of saw horses 42.

The workstation 10 comprises a plurality of jigs 54. Each jig 54 is reversibly couplable to a perimeter of a door that is positioned across the respective drawers 28. The jig 54 is positionable on the door such that the jig 54 is configured to guide preparation and repair of the door. In one embodiment, the plurality of jigs 54 comprises a hinge template 56, a door sticker template 58 and a double pantry door latch template 60.

In use, each drawer 28 is selectively and reversibly insertable through a respective slot 26 into the internal space 16. The pulls 36 are positioned on the front plates 32 such that the pulls 36 are configured for a user to motivate respective drawers 28 from inserted positions to open positions. The respective drawers 28 are configured to support a door that is positioned across the respective drawers 28, with a side of the door adjacent to the front faces 22. The jig 54 is positionable on the door such that the jig 54 is configured to guide preparation and repair of the door. The saw horses 42 are positioned on the cabinets 12 such that the saw horses 42 are positioned to pivot from the cabinets 12 to an extended configuration. The saw horses 42 are configured to support the table to provide a work surface. The jam holder 52 is positionable on the saw horse 42 such that the jam holder 52 is configured to hold a jam of a door that is positioned across the pair of saw horses 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A carpenter's workstation comprising:
a pair of cabinets, each said cabinet comprising:
a housing defining an internal space,
a plurality of slots positioned in a front face of said housing, and
a plurality of drawers, each said drawer being complementary to an associated one of said slots, said drawers being configured for positioning within said slots;
a pair of saw horses, each said saw horse being hingedly coupled to a rear of a respective said cabinet proximate to an upper limit of said respective said cabinet, said saw horses being collapsible; and
wherein each said drawer is selectively and reversibly insertable through a respective said slot into said internal space, such that respective said drawers are configured to support a door positioned across said respective said drawers with a side of the door adjacent to said front faces, wherein said saw horses are positioned on said cabinets such that said saw horses are positioned to pivot from said cabinets to an extended configuration.

2. The workstation of claim 1, further including said housing being substantially rectangularly box shaped.

3. (canceled)

4. (canceled)

5. (canceled)

6. The workstation of claim 1, further including said plurality of drawers comprising six said drawers.

7. The workstation of claim 1, further including each said drawer comprising:
a bottom plate;
a front plate coupled to a front edge of said bottom plate, said front plate extending angularly from said bottom plate such that said front plate is flush to said front face of said housing when said drawer is fully inserted into said respective said slot;
a pull coupled to said front plate, said pull being substantially centrally positioned on said front plate;
a recess positioned in said back face of said housing, said recess extending from a bottom to a top of said housing; and
wherein said pull is positioned on said front plate such that said pull is configured for a user to motivate said drawer from an inserted position to an open position.

8. The workstation of claim 7, further including said pull comprising an orifice positioned through said front plate, wherein said orifice is positioned through said front plate such that said orifice is configured for insertion of at least one digit of a hand of the user.

9. (canceled)

10. (canceled)

11. The workstation of claim 1, further including a table top, said table top being rigid, said table top being configured for positioning across said pair of saw horses when said saw horses are in the extended configuration wherein said table top provides a work surface for the user.

12. (canceled)

13. The workstation of claim 1, further including a pair of jam holders, each said jam holder being reversibly couplable to a respective said saw horse, wherein said jam holder is positionable on said saw horse such that said jam holder is configured to hold a jam of a door positioned across said pair of saw horses.

14. The workstation of claim 1, further including a plurality of jigs, each said jig being reversibly couplable to a perimeter of a door positioned across said respective said drawers, wherein said jig is positionable on the door such that said jig is configured to guide preparation and repair of the door.

15. The workstation of claim 14, further including said plurality of jigs comprising a hinge template, a door sticker template and a double pantry door latch template.

16. A carpenter's workstation comprising:
a pair of cabinets, each said cabinet comprising:
a housing defining an internal space, said housing being substantially rectangularly box shaped, said housing having a top and a bottom, said bottom being dimensionally larger that said top such that a front face of said housing extends angularly from said bottom to said top,
a plurality of slots positioned in said front face of said housing,
a plurality of drawers complementary to said slots, wherein each said drawer is selectively and reversibly insertable through a respective said slot into said internal space, said drawers being configured for positioning within said slots such that respective said drawers are configured to support a door positioned across said respective said drawers with a side of the door adjacent to said front faces, said plurality of drawers comprising from one to ten said drawers, said plurality of drawers comprising from two to eight said drawers, said plurality of drawers comprising six said drawers, each said drawer comprising:
a bottom plate,
a front plate coupled to a front edge of said bottom plate, said front plate extending angularly from said bottom plate such that said front plate is flush to said front face of said housing when said drawer is fully inserted into said respective said slot, and
a pull coupled to said front plate, said pull being substantially centrally positioned on said front plate, wherein said pull is positioned on said front plate such that said pull is configured for a user to motivate said drawer from an inserted position to an open position, said pull comprising an orifice positioned through said front plate, wherein said orifice is positioned through said front plate such that said orifice is configured for insertion of at least one digit of a hand of the user, and
a recess positioned in said back face of said housing, said recess extending from said bottom to said top of said housing;
a pair of saw horses, each said saw horse being hingedly coupled to a rear of a respective said cabinet proximate to an upper limit of said respective said cabinet, said saw horses being collapsible, wherein said saw horses are positioned on said cabinets such that said saw horses are positioned to pivot from said cabinets to an extended configuration;
a table top, said table top being rigid, said table top being configured for positioning across said pair of saw horses when said saw horses are in the extended configuration such that said table top is supported in a substantially horizontal position, wherein said table top provides a work surface for the user, said table top being foldable;
a pair of jam holders, each said jam holder being reversibly couplable to a respective said saw horse, wherein said jam holder is positionable on said saw horse such that said jam holder is configured to hold a jam of a door positioned across said pair of saw horses;
a plurality of jigs, each said jig being reversibly couplable to a perimeter of a door positioned across said respective said drawers, wherein said jig is positionable on the door such that said jig is configured to guide preparation and repair of the door, said plurality of jigs comprising a hinge template, a door sticker template and a double pantry door latch template; and
wherein each said drawer is selectively and reversibly insertable through a respective said slot into said internal space, wherein said pulls are positioned on said front plates such that said pulls are configured for a user to motivate respective said drawers from inserted positions to open positions, such that said respective said drawers are configured to support a door positioned across said respective said drawers with a side of the door adjacent to said front faces, wherein said jig is positionable on the door such that said jig is configured to guide preparation and repair of the door, wherein said saw horses are positioned on said cabinets such that said saw horses are positioned to pivot from said cabinets to an extended configuration, wherein said saw horses are configured to support said table to provide a work surface, wherein said jam holder is positionable on said saw horse such that said jam holder is configured to hold a jam of a door positioned across said pair of saw horses.
